(19) United States
(12) Patent Application Publication
(10) Pub. No.: US 2012/0127313 A1
(43) Pub. Date: May 24, 2012

(54) METHOD AND DEVICE FOR A VEHICLE-BASED ILLUMINATION IN INSUFFICIENTLY ILLUMINATED TRAFFIC ENVIRONMENTS

(76) Inventor: Tobias Ehlgen, Ravensburg (DE)

(21) Appl. No.: 13/321,949

(22) PCT Filed: May 20, 2010
(86) PCT No.: PCT/EP2010/056960

§ 371 Date: Feb. 13, 2012

(30) Foreign Application Priority Data
May 29, 2009 (DE) 10 2009 026 571.6

(51) Int. Cl. H04N 7/18; B60Q 1/14

(52) U.S. Cl. 348/149; 315/82; 348/E07.085

(57) ABSTRACT

In a method for a vehicle-based illumination of traffic environments, light is irradiated from a vehicle into a traffic environment to detect critical objects, with the intensity averaged over time being reduced when producing the light so as to prevent the human eye from being blinded. The light is irradiated intermittently into the traffic environment in accordance with ON periods and OFF periods. In an OFF period, no light is irradiated from the light source into the traffic environment, while during an ON period the light is irradiated in the traffic environment.

### BACKGROUND OF THE INVENTION

1. Field of the Invention

The present invention relates to the headlight control in vehicles.

2. Description of Related Art

It is known to equip vehicles with headlights in order to allow for an illumination in dark environments. Multifunction cameras (MPCs, multi-purpose camera) support the driver by detecting structures of the traffic environment, for example by detecting the lane. Depending on what is detected, the cameras are able to control the switchover between low beam and high beam, the high beam being switched off for example when detecting an oncoming vehicle so as to prevent blinding. It is furthermore known to use light in the infrared range for illumination since the human eye is not blinded by infrared light, yet electronic cameras are usually able to detect environments that are illuminated by infrared light.

Printed Japanese patent application document JP-2006176020-A describes a mechanism, which is used to protect other road users from being blinded in that a critical area (in which a pedestrian is located for example) is detected using a camera. The position of the critical object (the pedestrian) is displayed and, if indicated, following the detection of the direction, a respective headlight radiating in this direction is switched off. Thus, by continuously switching off a respective headlight, which radiates in a critical direction, the visibility distribution is adapted to the prevailing traffic situation and particularly to existing critical objects.

Printed German patent application document DE 197 138 44 A1 describes a method for regulating the lighting range of headlights in order to adapt these in anticipatory fashion to the requirements for illuminating the roadway. According to a detected traffic situation, the headlights are tilted into a curve. Additionally, it is described that the lighting range is reduced when a preceding vehicle is detected.

Thus, according to the related art, when detecting a critical object (preceding vehicle, pedestrian), the object is excluded from direct irradiation, in that the direction of illumination is changed. Due to the low number of different selectable illumination directions of a normal headlight (e.g. low beam or high beam), not only specifically the section, in which a critical object is located, is suppressed, but rather an entire illumination region is permanently switched off. This clearly reduces the illuminated field of view discernible by the driver in order to take into account the traffic environment and in particular critical objects in the traffic environment. Yet it is precisely the sections of a picture, within which critical objects are located, that are of special significance to the driver.

It is therefore an objective of the present invention to provide a mechanism allowing for the adaptive illumination of a traffic environment, which prevents on the one hand other road users from being blinded, and on the other hand still allows for the entire traffic environment to be sufficiently discerned even when adapting the illumination.

### BRIEF SUMMARY OF THE INVENTION

The method according to the present invention and the device according to the present invention make it possible to adapt a vehicle-based illumination of traffic environments to detect critical objects in order to protect road users from being blinded without degrading the visual grasp of the traffic environment as a whole. In particular, the present invention may be implemented by already existing cost-effective systems. Moreover, critical objects, which are to be protected against blinding, are detected completely and in illuminated fashion even after adapting the illumination, without the danger of blinding.

The present invention is based on the concept of greatly minimizing the danger of blinding in that the environment is illuminated only for short ON periods in order to be able to continue to illuminate the traffic environment as before, blinding being at the same time prevented in that the average intensity relevant for blinding a human eye is clearly reduced. In order to be able to use the illumination during the ON periods for the human eye, a camera is used, which takes a picture preferably during the ON period (because of the high intensity during the ON period, the shutter times can be very brief), it then being possible to display the recorded camera image to the driver for orientation. For this purpose, either the recorded camera image itself may be displayed, or merely symbols, for example a circle that represents the position of relevant objects. In this context, relevant objects mean traffic signs or the course of the roadway as well as other road users. The present invention thus makes use of the principle that the human eye takes up brightness with a certain lag and that thus high momentary intensities do not blind if the ON period of the light is sufficiently short in comparison to the lag of the human eye and the intensity averaged over time is markedly lower. The behavior of an electronic camera differs from the human eye by the fact that even brief flashes of light used for illumination provide a sufficient illumination, and that a picture may be taken if a shutter time or image recording time is used that is very short in comparison to the lag of the human eye. The time of taking the picture is thus synchronized with the clocked illumination, and a picture is taken preferably in the ON period, during which the light source produces light, i.e. is supplied with current. All electrical light sources that have a low lag are suitable as light sources. While light sources based on coiled filaments are less suited for producing light only during short ON periods because of the afterglowing wire, LED light sources are particularly suited for producing a clocked illumination having clearly defined ON and OFF periods for implementing the present invention.

The method according to the present invention for the vehicle-based illumination of traffic environments therefore includes the generation of light by at least one light source, which is radiated from a vehicle into a traffic environment. The light sources are thus oriented forward or also backward, when viewed relative to the vehicle. The light is irradiated intermittently into the traffic environment in accordance with ON periods and OFF periods. Preferably, the switch between the periods occurs at a frequency that is above 15, 20, 25 or above 50 Hz such that the human eye does not perceive the succession of ON and OFF periods as flickering or perceives it only slightly as such. In particular, the switching frequency may be 50 Hz or 100 Hz, such a frequency being able to be implemented by LED light sources without the ON period being extended by afterglow effects, the light sources at the same time having a low lag such that the brightness rises at the beginning of the ON period at a suitably high rate of increase.

During the OFF period, no light is irradiated by the light source into the traffic environment or into a sector of the traffic environment so as to prevent blinding. During the ON period, light is irradiated in the traffic environment essentially into the same traffic environment, i.e. into the same sector. The ON period is used for taking a picture, the length of the ON period at the same time ensuring that a human eye is not blinded. A picture (or even multiple pictures) of the traffic environment and in particular of the sector illuminated during the ON period is taken during the ON period. Taking the picture begins with the ON period and ends with the same ON period. Alternatively, taking the picture begins with the ON period and ends within the same ON period. According to another specific embodiment, taking the picture begins within the ON period and ends with or within the same ON period. Alternatively, taking the picture may also begin prior to the ON period as long as the period, in which the picture is taken, overlaps at least partially with the ON period. For this purpose, a camera having a respective shutter time may be provided, electronic cameras in particular defining the recording period, within which the picture is taken, by reading out an electronic image sensor. In electronic cameras, taking the picture thus corresponds to a recording time period, during which the pixels of an image sensor are read out. This recording period is synchronized with the ON period and overlaps at least partially with the ON period.

The illumination according to the present invention at reduced average intensity is provided when a critical object is detected. If no critical object is detected, there are preferably only ON periods.

The light is irradiated over the ON and OFF periods at an average intensity value that is lower than the intensity during the ON period. This measure, in combination with the lag of the human eye, prevents blinding. The average intensity value over the ON and OFF periods is preferably no greater than 10%, 5%, 2%, 1%, 1%, 0.1 or 0.01% of the intensity or the average intensity value during an ON period. Furthermore, according to the present invention, the generation of light at reduced average brightness includes the operation of an electrical light source clocked according to a square-wave signal or according to another pulse signal that defines the ON period and the OFF period. The ON period is defined by a signal strength that is higher than a predefined value, the OFF period being defined by a signal value that is below the predefined value. Preferably, the light generation, which is controlled by the signal, is essentially 0 during the OFF period and essentially 100% during the ON period or in particular >90% of a standard value reflecting the standard intensity of the light source. The control signal, according to which the light source is switched on and off, is provided at a pulse control factor no greater than 10%, 5%, 2%, 1%, 1%, 0.1 or 0.01%. The pulse control factor is thus clearly lower than 1 and concerns the length of the ON period in relation to the sum of the ON period and the OFF period. The pulse control factor may equally be defined by the relation of the integral of the light generation intensity or the signal value over the ON period in relation to the integral of the intensity or signal value over the ON and the OFF period over the entire time period during which light is generated in the manner according to the present invention.

In order to achieve the desired averaging effect by the lag of the human eye, which prevents blinding, the ON period and the OFF period follow in quick temporal alternation. As remarked above, the alternation may be represented by a frequency. Alternatively, an ON period is defined at a length of no more than 200 ms, 100 ms, 50 ms, 20 ms, 10 ms, 5 ms, 1 ms, 200 μs, 100 μs, 50 μs or 30 μs. In order to provide the averaged intensity so that it is clearly lower than the momentary intensity, the OFF period is a multiple N of the ON period. N is preferably ≧10, ≧20, ≧50, ≧100, ≧1000, ≧10000 or ≧100000. In order to avoid a flickering that would be annoying to the human eye, the ON periods and the OFF periods alternate at a frequency of ≧20 Hz, the ON period not lasting longer than 25 μs. This results in a ratio of the average intensity value to the momentary intensity during the ON period of <50%. An intensity of 100% may thus be used for taking the picture, whereas the human eye is confronted with an intensity of 50%, whereby the blinding effect is clearly reduced. The ratio of the average intensity value to the momentary intensity is preferably less than 25%, less than 10%, less than 5%, less than 1%, less than 1% or less than 0.01%. The pulse duty factor corresponds to the ratio of the average intensity value over time to the momentary intensity during the ON period and vice versa. Furthermore, the average intensity value during the ON period may be set equal to the momentary intensity during the ON period and vice versa.

According to another aspect of the present invention, multiple light sources are used, which are oriented in different directions, the light sources being operated individually in accordance with the present invention when a critical object is present in the illumination cone or in the respective illumination direction of a particular light source. In the OFF period, one of the light sources, which is oriented in one particular direction, generates no light, while during the OFF period at least one different, second light source, which is oriented in a different direction, generates light. In the ON period, the at least one first as well as the at least one second light source generates light. Preferably, during the OFF period, the light sources or light source are/is switched off only if an object exists in the respective direction, which is exposed to the danger of being blinded, a pedestrian or a vehicle for example.

The method according to the present invention furthermore includes the step of detecting a critical direction, in which a light-sensitive object exists in the traffic environment. In this context, light-sensitive means that the object experiences blinding if is illuminated with light of an excessively high intensity. This concerns in particular objects such as vehicles or pedestrians, the driver or the pedestrian being possibly blinded by the light source if the latter has an excessively high intensity averaged over time. According to the present invention, at least one light source is assigned to the critical direction. This is provided in particular in that different light sources are oriented in different directions of irradiation. The direction of irradiation is defined by the attachment or mounting of the light source such that the individual light cone directions are easily assigned to the associated light sources. The assignment is therefore provided by the attachment of the light source or by its orientation, in particular if the light source is fastened in a movable bearing. During the OFF period, the at least one light source, which lies in the critical direction, is switched off. Other light sources, which are not oriented in the critical direction, remain switched on during the OFF period. The OFF period therefore concerns only those light sources that irradiate in a critical direction or onto a light-sensitive object in the traffic environment. In addition to the attachment, which defines direction of irradiation of a specific light source, the optical system, which is possibly movable, also influences the direction of irradiation of the light source if the optical system is used to define the optical path of the respective light source.

The present invention is furthermore implemented by a device for the vehicle-based illumination of traffic environments, the device including: at least one vehicle light source, which is oriented into a traffic environment and irradiates into it. The device furthermore includes at least one clock pulse generator, which supplies the vehicle light source, the clock pulse generator supplying the vehicle light source intermittently with electrical current according to an ON period and an OFF period. The clock-pulse generator may be provided for example by a microprocessor, which controls a power switch (preferably semiconductor-based) and which is connected to the latter for this purpose. The power switch is provided in the electric circuit that supplies the light source with current. The clock pulse generator supplies the vehicle light source intermittently with electric current according to an ON period and an OFF period. The supply may be provided directly via the clock pulse generator, which provides a current required for light generation, or may be provided by an electric circuit, which supplies the light source with current, and which controls the current flow in accordance with the clock pulse generator. The device furthermore includes a picture taking device, for example an electronic camera, which is indirectly or directly connected to the generator, and which is set up to take pictures of the traffic environment during the ON period, as is already described with reference to the method according to the present invention.

In order to ensure that the taking of the picture is synchronized with the ON period light source, as is described above with reference to the method according to the present invention, the device according to the present invention includes a synchronization device, which outputs a picture taking carrier signal to the connected picture taking device at the beginning of the ON period or offset by a predefined delay. The picture taking device is thus connected to the synchronization device via a data line, via which the carrier signal is transmitted. Furthermore, the synchronization device may also be set up to output the carrier signal to the picture taking device a predefined time period prior to the ON period. The synchronization device is furthermore connected to the clock pulse generator for detecting the ON period. According to an alternative specific development, the clock pulse generator itself outputs to the picture taking device, the synchronization device in this case being provided by the clock pulse generator itself and by the connection between the clock pulse generator and the picture taking device. The picture taking device includes a carrier signal input, via which the carrier signal is received, and by which the trigger time or picture taking time of the picture taking device may be controlled.

The device according to the present invention furthermore includes an object detection device, which is connected to the picture taking device. The object detection device is developed to detect objects, in particular light-sensitive objects, in the picture that is provided by the picture taking device. Furthermore, the object detection device (or another assignment device of the device according to the present invention) is developed to assign the objects to critical directions. Critical directions are defined by the orientation of the at least one vehicle light source. The objects are preferably classified by the object detection device and are categorized into non-light-sensitive objects such as traffic signs or roadway features and light-sensitive objects such as people or vehicles. The classification may be performed for example on the basis of the contour of the detected objects. The object detection device assigns critical directions preferably to a plurality of vehicle light sources oriented in various directions, the vehicle light sources being part of the device. The clock pulse generator is designed not to supply current to the vehicle light source or vehicle light sources, which are oriented in the critical direction or in the critical directions, during the OFF period. However, the vehicle light source or vehicle light sources, which are not oriented in the critical direction, continue to be supplied with current during the OFF period. The clock pulse generator is thus connected to the object detection device and is designed to provide different signals for multiple vehicle light sources so as not to supply those light sources with current during the OFF period that are oriented in the critical direction.

The vehicle light source includes an LED headlight with exactly one current supply terminal, which is connected to a clock pulse generator or an electric circuit that is controlled by the clock pulse generator. The vehicle light source may likewise include a plurality of LED elements that all have individual current supply terminals. The LED elements of the plurality of LED elements may be oriented in different directions so as to provide an irradiation cone oriented in different directions in order thus to be operated individually in accordance with the method of the present invention if a light-sensitive object or a critical object exists in the direction of irradiation of the LED elements. Furthermore, a plurality of LED elements may be provided, which are grouped in accordance with their orientation. Grouping in this context means that the LED elements of a group have a common current supply terminal, and different groups have different current supply terminals. Consequently, each group has an individual current supply terminal, each group being assigned to a specific orientation. As a result, the groups of LED elements may be supplied with electrical current individually and separately via a connection to the clock pulse generator or via a connection to an electrical circuit that is controlled by the clock pulse generator.

According to a special specific embodiment, the at least one vehicle light source includes at least two LED headlights, each LED headlight including a plurality of LEDs, which are fastened in a common mounting support and are oriented in a specific direction. The LEDs may be arranged along a curve that corresponds to a parabolic mirror, each LED including a lens, which together with the crystal producing the light in the LED provides an optical axis, which together with the other optical axes of the LEDs of the LED headlight is oriented in one direction. The lens of each LED is provided by a translucent, cast encapsulation of the LED, which forms both a housing as well as a lens for a light-producing crystal in one piece. In addition to a mounting support, which arranges multiple LEDs in the form of a parabolic mirror, the LEDs may also be provided in one plane and may possibly be oriented toward a common focal point.

### BRIEF DESCRIPTION OF THE DRAWINGS

FIG. 1 shows a device according to the present invention having three vehicle light sources.

FIG. 2 shows a time characteristic diagram of the intensity of a vehicle light source operated according to the present invention.

### DETAILED DESCRIPTION OF THE INVENTION

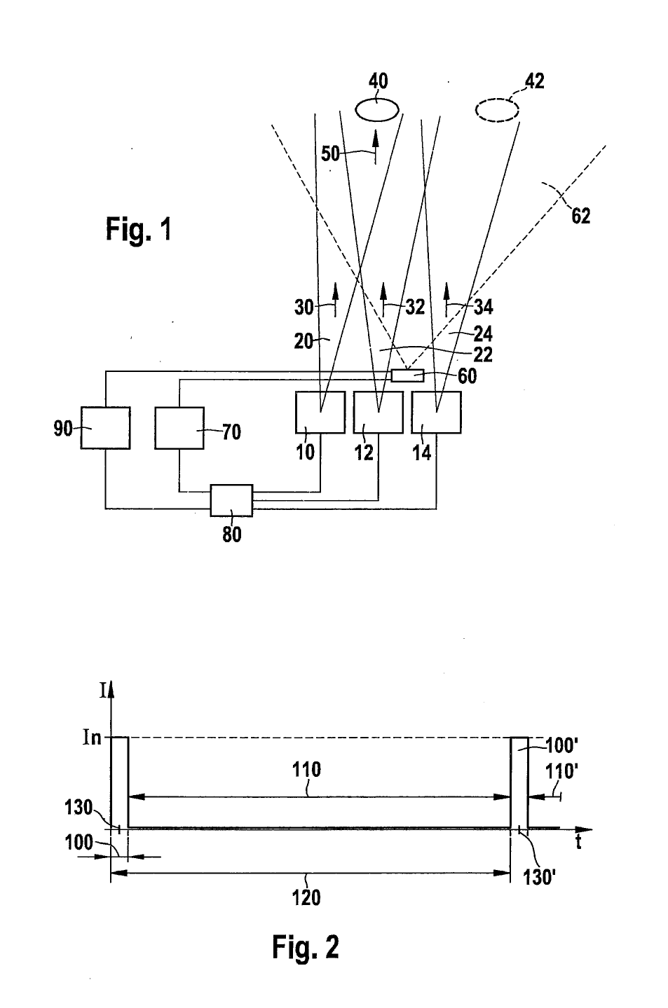

FIG. 1 shows a device according to the present invention having three vehicle light sources, 10, 12, 14, which respectively irradiate light in a predefined light cone 20, 22, 24. The orientation of the light cones is represented by a respective direction 30, 32, 34.

A first object 40, represented by a solid line, is located in light cone 20, 22 of light sources 10, 12. From the perspective of light sources 10 and 12, object 40 is situated in a critical direction 50. Direction 50 corresponds to directions 30, 32 of light sources 10, 12. If light sources 10, 12 are operated at high intensity, then object 40, for example a pedestrian or an oncoming vehicle, is blinded by the high intensity.

For this reason, light sources 10, 12, the orientation 30, 32 of which lies in the critical direction 50, in which object 40 is located, are operated according to the method of the present invention such that light sources 10, 12 emit an intensity that is reduced by clocking and averaged over time. Because of the lag of object 40, the latter is not blinded, even though light sources 10, 12 emit light of high intensity during the ON periods. While object 40 is located in the orientations 30, 32 of light sources 10, 12 and the latter are operated using the method according to the present invention for reducing the averaged intensity, light source 14 emits a light cone 24 in a direction 34 that is not in the critical direction 50 of object 40. Hence light source 14 may be operated continuously at a high (momentary) intensity, which corresponds to the averaged intensity. In other words, the pulse control factor of the current supply of light source 14 is approximately 100%. While the orientations 30, 32, 34 are defined by the attachment of light sources 10-14, the critical direction 50, in which object 40 is located, is detected by picture taking device 60 and a connected object detection device 70. The capture cone of picture taking device 60 includes essentially the entire illumination cone or illumination cones 20-24 of light sources 10-14. A picture captured by picture taking device 60 is transmitted via a connection to object detection device 70, which ascertains the critical direction 50. According to this direction, light sources 10, 12, 14 are controlled by a clock pulse generator 80 of the device such that light sources 10, 12, which irradiate in direction 50, are operated in accordance with the present invention, light source 14 being controlled by clock pulse generator 80 in such a way that it continuously produces light at a continuous intensity.

The device according to the present invention moreover includes a synchronization device 90, which is connected to the picture taking device or to a trigger input of the picture taking device 60. Synchronization device 90 is hence able to emit a signal to picture taking device 60 in order to control the time at which picture taking device 60 takes a picture. Synchronization device 90 is additionally connected to clock pulse generator 80, from which synchronization device 90 receives a time signal that represents the ON period. For example, a rising edge of clock pulse generator 80 may prompt synchronization device 90 to emit likewise a rising edge to the trigger input of picture taking device 60, which then takes a picture. In this example, clock pulse generator 80 is used as a synchronization master unit. Alternatively, the synchronization device may also function as a master unit, in that it produces a clock pulse signal according to a clock pulse generator and emits this signal via the respective connections to picture taking device 60 and clock pulse generator 80. According to another alternative, picture taking device 60 may function as the master unit, in that it produces a signal, which is transmitted via synchronization device 90 to clock pulse generator 80, which thereupon controls light sources 10, 12 according to the ON period. If clock pulse generator 80 or picture taking device 60 function as master unit, then synchronization device 90 may be provided as a simple data transmission connection for a carrier signal.

At another point in time or in another traffic situation, no object 40 may exist, but rather alternatively an object 42, represented by dashed lines, which exists only in illumination cone 24 of light source 14, and which does not lie in direction 30, 32 of light sources 10, 12. In this case, picture taking device 60 captures object 42 (including the entire traffic environment), whereupon object detection device 70 ascertains object 42 and thus its direction and thereby controls clock pulse generator 80 in such a way that light source 14, which is directed upon object 42, is operated in accordance with the present invention and that the light sources 10, 12, which are not directed upon the object, are by contrast operated at a continuous intensity.

According to another traffic situation, both objects 40, 42 may be provided, object detection device 70 then detecting that objects exist in all illumination cones 20, 24 and thus in all orientations 30, 34 of all light sources 10, 14. In this case, clock pulse generator 80 produces a clocked signal for all light sources 10, 14 in order to operate light sources 10-14 in accordance with the method of the present invention at a low average intensity.

If one or all light sources 10-14 is/are operated at a lower average intensity, then picture taking device 60 takes a picture, preferably during the ON period or even only during the ON period, in accordance with the capture breadth 62 of the picture taking device, which includes in its breadth the illumination cones 20-24 of light sources 10-14.

FIG. 2 shows the intensity of a light source operated according to the present invention with reference to a time characteristic diagram. Intensity 1 is plotted on the vertical axis, whereas time curve t is plotted in the horizontal axis. During ON period 100, which repeats, the respective light source produces a standard intensity In, which corresponds to the standard power of the light source. The ON period is followed by an OFF period 110, in which the intensity essentially amounts to zero. OFF period 110 is followed by another ON period 100′, during which the light source irradiates the full intensity In. The ON period is followed by another OFF period 110′. The ON periods (and thus also the OFF periods) repeat in accordance with a repetition duration 120. The picture taking times 130, 130′, at which the picture taking device takes a picture of the traffic environment, are in the ON periods. The times of picture taking 130, 130′ are synchronized with the ON periods and fall within the ON period, preferably delayed by a predefined time period with respect to the rising edge of the ON period.

In the example shown in FIG. 2, the ON period lasts 1 ms, the OFF period 110 lasts 29 ms and the repetition duration 120 thus lasts 30 ms (ON period+OFF period). A repetition frequency of approx. 33 Hz thus results at a pulse control factor equal to the ratio between the ON period and the sum of the ON period and the OFF period=1 ms: 30 ms= 1/30. The average intensity thus amounts to 1/30 In or approx. 3% of In.

If a change of the brightness is desired, then this may occur by extending the ON period at the expense of the OFF period, the repetition frequency preferably remaining constant. The repetition frequency is preferably above a flicker frequency, beginning with which the human eye perceives a change in intensity as a flickering interference.

1-10. (canceled)

11. A method for a vehicle-based illumination of traffic environment, comprising:
irradiating, using at least one light source in a vehicle, light from the vehicle into a traffic environment, the light having a momentary intensity sufficient for blinding the human eye; and
detecting at least one critical object in the traffic environment with the aid of the irradiated light;
wherein, when a critical object is detected, the intensity of the light averaged over time is reduced in order to prevent blinding the human eye, by irradiating the light intermittently into the traffic environment in accordance with ON periods and OFF periods, wherein the light source irradiates no light into the traffic environment during the OFF periods, and wherein the light is irradiated into the traffic environment during the ON periods.

12. The method as recited in claim 11, further comprising:
taking a picture of the traffic environment during a selected ON period, wherein the taking of the picture begins and ends within the selected ON period.

13. The method as recited in claim 11, wherein the light is irradiated over the ON and OFF periods at an average intensity value which is no higher than 10% of the average intensity value of the light irradiated during an ON period.

14. The method as recited in claim 11, wherein the ON period has a duration no longer than 100 ms, and the OFF period has a duration which is a multiple N of the ON period, where N>10.

15. The method as recited in claim 11, wherein at least two light sources are provided, and wherein in the OFF period a first light source oriented in a first direction produces no light while a second light source oriented in a second direction produces light, and wherein in the ON period both the first and second light sources produce light.

16. The method as recited in claim 15, further comprising:
determining a critical direction in which a light-sensitive object exists in the traffic environment;
assigning to the critical direction a light source which lies in the critical direction; and
during the OFF period, switching off the assigned light source which lies in the critical direction and switching ON the other light source which is not oriented in the critical direction.

17. A device for a vehicle-based illumination of traffic environments, comprising:
at least one vehicle light source oriented towards a traffic environment and configured to irradiate light having a momentary intensity sufficient for blinding the human eye;
an object detection device configured to detect at least one critical object;
a picture taking device connected to the clock pulse generator and configured to take pictures of the traffic environment during the ON periods; and
at least one clock pulse generator configured to selectively supply electrical current to the vehicle light source intermittently in accordance with ON periods and OFF periods when a critical object is detected, to reduce the intensity of the irradiated light averaged over time to prevent the human eye from being blinded.

18. The device as recited in claim 17, further comprising:
a synchronization device connected to the picture taking device and configured to output a picture taking trigger signal to the picture taking device at one of (i) the start of an ON period or (ii) a time point offset from the start of the ON period by a predetermined delay, wherein the synchronization device is also connected to the clock pulse generator for the purpose of detecting the ON period.

19. The device as recited in claim 17, wherein:
the object detection device is connected to the picture taking device and configured to detect a light-sensitive object as the at least one critical object in the picture and to assign the detected light-sensitive object to a critical direction;
a plurality of vehicle light sources are provided and oriented in different directions; and
the clock pulse generator is configured to (i) not supply current during the OFF periods to the vehicle light sources which are oriented in the critical direction, and (ii) supply current during the OFF periods to the vehicle light sources which are not oriented in the critical direction.

20. The device as recited in claim 17, wherein the at least one vehicle light source includes an LED headlight having multiple LED elements, and wherein each LED element has an individual current supply terminal in order to be supplied individually with electrical current.
